(19) United States
(12) Patent Application Publication
(10) Pub. No.: US 2008/0265907 A1
(43) Pub. Date: Oct. 30, 2008

(54) Fuse Sensing Method and Apparatus

(76) Inventor: Hermann Wienchol, Raleigh, NC (US)

Correspondence Address: COATS & BENNETT/QIMONDA, 1400 CRESCENT GREEN, SUITE 300, CARY, NC, 27518, US

(21) Appl. No.: 11/741,351

(22) Filed: Apr. 27, 2007

(51) Int. Cl. H01H 85/30

(52) U.S. Cl. 324/550

(57) ABSTRACT

Fuse sensing is performed in an integrated circuit by selecting a reference voltage based on a temperature measurement acquired by the integrated circuit. A state of one or more fuses included in the integrated circuit is sensed based on the reference voltage during normal operation of the integrated circuit. The state of the one or more fuses may be sensed during testing of the integrated circuit based on a different reference voltage.

### BACKGROUND OF THE INVENTION

Fuse arrays comprise a plurality of fuse elements such as metal fuses or electronic fuses (e-fuses). A fuse element stores one bit of information corresponding to its programmed state. For example, some fuse types initially have a low resistance state until programmed. Once programmed, fuse resistance increases drastically. Other fuse types such as antifuses initially have a high resistance before programming and a low resistance after programming. As used herein, the term ‘fuse’ should be construed to include both fuses and antifuses. Fuse arrays are conventionally programmed prior to use in the field, e.g., during test by applying a high voltage or current to the fuse elements to be programmed.

The state of a fuse element is sensed by first applying a reference voltage to sense circuitry coupled to the fuse element. The difference between the reference voltage and the voltage output by the fuse charges the sense circuitry to a level suitable for detecting the fuse state after the reference and fuse voltages are removed from the sense circuitry. That is, if the fuse voltage corresponds to a logic one fuse state, the difference between the reference voltage and the fuse voltage conditions the sense circuitry for detecting a logic one. Conversely, if the fuse voltage corresponds to a logic zero fuse state, the voltage difference conditions the sense circuitry for detecting a logic zero. After the sense circuitry is charged, the reference and fuse voltages are removed from the circuitry. The sense circuitry then detects the fuse state based on the conditioned state of the sense circuitry. Thus, proper selection of the reference voltage with respect to fuse voltage enables accurate and reliable fuse sensing.

The voltage output by a fuse is a function of fuse resistance. Fuse resistance varies with temperature. Thus, proper selection of the reference voltage proves a difficult task when fuse array temperature varies sufficiently. This is particularly true for mobile applications where extreme temperature variations occur often. A reference voltage not based on the actual operating temperature of an integrated circuit may prove suitable under some temperature conditions, but not others. If the reference voltage is too high or low with respect to fuse voltage, fuse sensing becomes inaccurate and unreliable.

### SUMMARY OF THE INVENTION

According to the methods and apparatus taught herein, fuse sensing is performed in an integrated circuit by selecting a reference voltage based on a temperature measurement acquired by the integrated circuit. A state of one or more fuses included in the integrated circuit is sensed based on the reference voltage during normal operation of the integrated circuit. The state of the one or more fuses may be sensed during testing of the integrated circuit based on a different reference voltage.

Of course, the present invention is not limited to the above features and advantages. Those skilled in the art will recognize additional features and advantages upon reading the following detailed description, and upon viewing the accompanying drawings.

### BRIEF DESCRIPTION OF THE DRAWINGS

FIG. 1 is a block diagram of an embodiment of an integrated circuit including fuse sensing circuitry.

FIG. 2 is a logic flow diagram of an embodiment of program logic for fuse sensing by the integrated circuit of FIG. 1.

FIG. 3 is a block diagram of an embodiment of the fuse sensing circuitry included in the integrated circuit of FIG. 1.

FIG. 4 is a block diagram of an embodiment of a soft latch included in the fuse sensing circuitry of FIG. 3.

FIG. 5 is a block diagram of an embodiment of a temperature-to-voltage converter included in or associated with the fuse sensing circuitry of FIG. 1.

FIG. 6 is a block diagram of an embodiment of a controller included in or associated with the fuse sensing circuitry of FIG. 3.

### DETAILED DESCRIPTION OF THE INVENTION

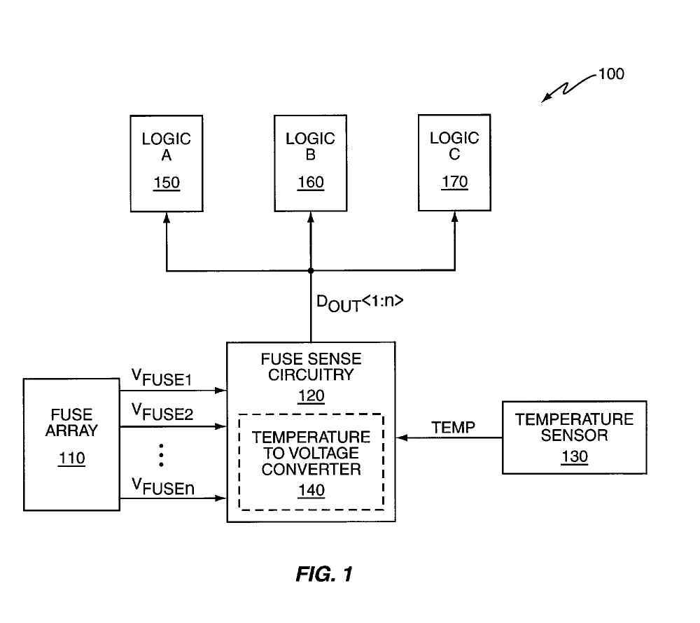

FIG. 1 illustrates an embodiment of an Integrated Circuit (IC) 100 including a fuse array 110 and fuse sense circuitry 120. The IC 100 may be any kind of analog, digital or mixed-signal device such as a memory device, microprocessor, digital signal processor, application-specific integrated circuit or the like. The fuse array 110 comprises an arrangement of fuse elements (not shown) for storing any kind of information such as redundancy information, resistance trimming values, device IDs, timing parameters, etc. The fuse sense circuitry 120 accounts for the operating temperature of the IC 100 when sensing the state of the fuse elements. The state of the fuse array 110 is more accurately and reliably detected when temperature is accounted for during fuse sensing because fuse resistance varies with temperature.

The IC 100 further includes a temperature sensor 130 such as the kind well known in the art for sensing temperature. The IC 100 may include a single temperature sensor 130 located near the fuse array 110. Alternatively, the IC 100 may include multiple sensors 130 if the IC 100 includes multiple fuse arrays 110, each sensor 130 located near a fuse array 110. This way, the temperature of each fuse array 110 is accurately determined. Regardless, the temperature sensor 130 provides a temperature measurement (TEMP) to the fuse sense circuitry 120. The temperature measurement may be analog or digital when received by the sense circuitry 120.

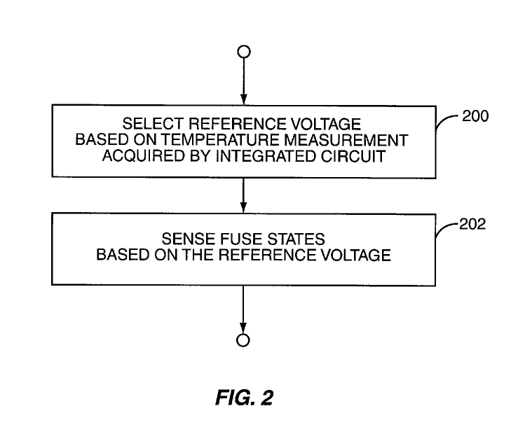

A temperature-to-voltage converter 140 included in or associated with the fuse sense circuitry 120 selects a reference voltage based on the temperature measurement, e.g., as illustrated by Step 200 of FIG. 2. The sense circuitry 120 detects the state of the fuse array 110 based on the reference voltage, e.g., as illustrated by Step 202 of FIG. 2. In more detail, the reference voltage and fuse voltages V_{FUSE1} to V_{FUSEn} output by the fuse array 110 are applied to the sense circuitry 120 during fuse sensing. The voltage output by a fuse element represents the state of the fuse, i.e., whether the fuse has be programmed or not. The difference between the reference voltage and the fuse voltages advantageously condition the sense circuitry 120 for accurately detecting the state of each fuse element. The sense circuitry 120 senses and captures the state of each fuse element after being conditioned by the reference voltage. The sense circuitry 120 provides the captured fuse data (DOUT<1:n>) to logic circuitry 150, 160, 170 included in the IC 100. The logic circuitry 150, 160, 170 may comprise any kind of analog, digital or mixed-signal circuitry such as one or more memory arrays, processor pipeline stages, combinatorial logic, registers, amplifiers, filters, receivers, transmitters, etc. The logic circuitry 150, 160, 170 implements functionality supported by the IC 100 based at least in part on the fuse data received from the sense circuitry 120.

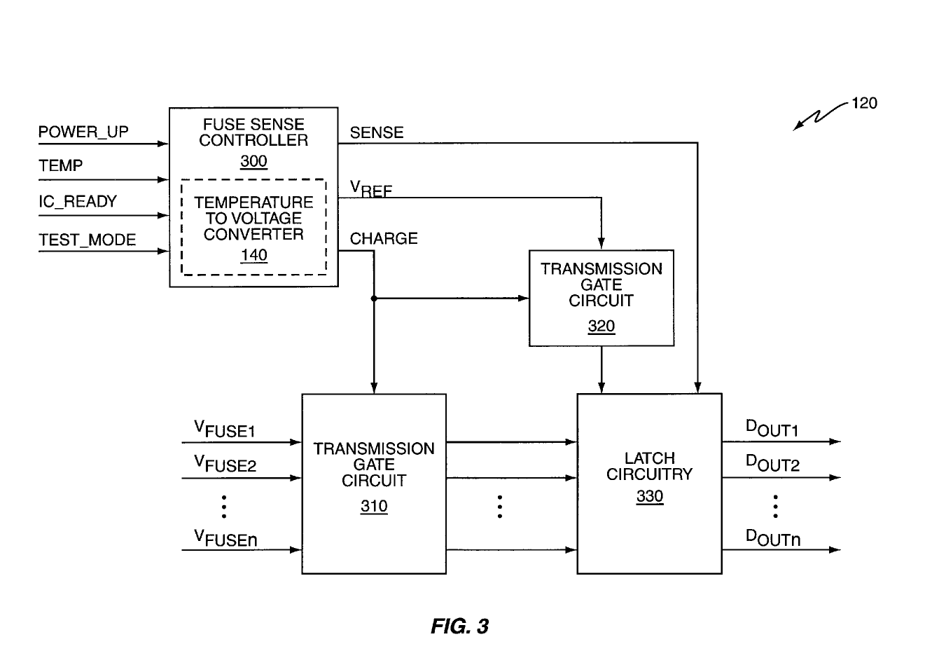

FIG. 3 illustrates one embodiment of the fuse sense circuitry 120. The circuitry 120 includes a controller 300, first and second transmission gate circuits 310, 320 and latch circuitry 330. The latch circuitry 330 includes a plurality of latches (not shown) such as soft latches coupled to respective ones of the fuse elements included in the fuse array 110. The latches sense and capture the state of the fuse element to which they are coupled based on the reference voltage (V_{REF}) applied to the latch circuitry 330. The controller 300 manages fuse sensing operations including when the reference voltage is applied to the latch circuitry 330 and at what level.

In one embodiment, fuse sensing occurs during normal operation of the IC 100, i.e., when the IC 100 is not configured in test mode. For example, the fuse controller 300 initiates fuse sensing during normal IC operation when the IC 100 is powering up (POWER_UP signal is active), but before the IC 100 is ready to process information (IC_READY signal not yet active). The reference voltage used to condition the latch circuitry 330 during fuse sensing is determined by the temperature-to-voltage converter 140 included in or associated with the controller 300 when fuse sensing occurs during normal operation of the IC 100. This way, temperature is accounted for when fuse sensing during normal IC operation. In another embodiment, the controller 300 uses a different reference voltage for sensing fuse states when the IC 100 is in test mode (TEST_MODE signal is active) as will be described in more detail later.

Regardless, the controller 300 carries out fuse sensing in two stages. During a charging stage, each latch included in the latch circuitry 330 is charged to a level corresponding to the state of the fuse element to which the latches are coupled. During a sensing stage, fuse states are sensed based on the charged levels of the latches. The level at which a particular latch is charged corresponds to the difference between the reference voltage V_{REF} applied to the latch and the fuse voltage (V_{FUSE1}, V_{FUSE2}, . . . , V_{FUSEn}) output by the fuse element to which the latch is coupled.

In more detail, the controller 300 activates the first and second transmission gate circuits 310, 320 during the charging stage by activating a charge signal (CHARGE). The first transmission gate circuit 310 passes the fuse voltages V_{FUSE1} through V_{FUSEn} output by the fuse array 110 to the latch circuitry 330 when activated. The second transmission gate circuit 320 passes the reference voltage V_{REF} to the latch circuitry 330 when activated. Each latch is charged to a level corresponding to the difference between the reference voltage and the fuse voltage applied to the latch. By charging the latches to a suitable level, fuse states may be accurately and reliably detected after the reference and fuse voltages are removed from the latch circuitry 330.

After the latch circuitry 330 is charged, the controller 300 deactivates the first and second transmission gate circuits 310, 320. The latch circuitry 330 is decoupled from the fuse voltages and the reference voltage when the first and second transmission gate circuits 310, 320 are turned off. The controller 300 then activates a sense signal (SENSE) applied to the latch circuitry 330 during the sensing stage. The sense signal causes each latch to sense the state of the fuse element to which it is coupled based on the charged level of the latches. That is, the conditioned state of each latch determines whether a programmed or un-programmed fuse state is sensed and captured by the latches. The latch circuitry 330 also stores the sensed fuse states (DOUT1 to DOUTn) for use by the logic circuitry 150, 160, 170.

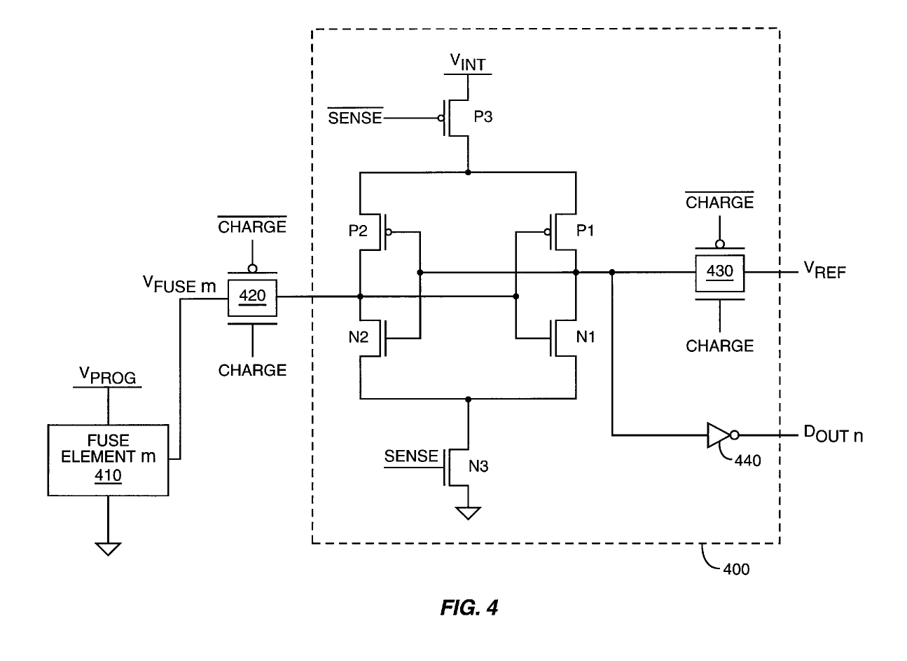

FIG. 4 illustrates an embodiment of a soft latch 400 included in the latch circuitry 330. The soft latch 400 is coupled to the m^{th} fuse element 410 of the fuse array 110 when a first transmission gate 420 is active and to the fuse controller 300 when a second transmission gate 430 is active. The first and second transmission gates 420, 430 are activated when the fuse controller 300 activates the CHARGE signal during the charging stage of a fuse sensing operation. The first transmission gate 420 passes the fuse voltage (V_{FUSEm}) output by the m^{th} fuse element 410 to the soft latch 400 when activated and the second transmission gate 430 passes the reference voltage (V_{REF}) to the soft latch 400 when activated. The fuse voltage identifies whether the m^{th} fuse element 410 has been programmed or not. For example, the fuse voltage may be high if the m^{th} fuse element 410 has a low-resistance programmed or un-programmed state. Similarly, the fuse voltage may be low if the m^{th} fuse element 410 has a high-resistance programmed or un-programmed state. Regardless, the soft latch 400 charges to a level corresponding to the difference between V_{REF} and V_{FUSEm}.

In more detail, the soft latch 400 comprises two p-fet transistors P1 and P2 and two n-fet transistors N1 and N2. P-fet transistor P1 and n-fet transistor N1 are coupled in an inverter arrangement where they share a common drain connection. Likewise, p-fet transistor P2 and n-fet transistor N2 are also coupled in an inverter arrangement sharing a common drain connection. The sources of the p-fet transistors P1 and P2 are coupled to the drain of a third p-fet transistor P3 while the sources of the n-fet transistors N1 and N2 are coupled to the drain of a third n-fet transistor N3. P-fet transistor P3 and n-fet transistor N3 provide power (V_{INT}) and ground, respectively, to the soft latch 400 when enabled. P-fet transistor P3 and n-fet transistor N3 are enabled when the fuse controller 300 activates the SENSE signal during the sensing stage of a fuse sensing operation.

During the charging stage of a fuse sensing operation, V_{FUSEm} is applied to the common gate of the first inverter P1/N1 and to the common drain of the second inverter P2/N2. Likewise, V_{REF} is applied to the common gate of the second inverter P2/N2 and to the common drain of the first inverter P1/N1. The difference between V_{REF} and V_{FUSEm} determines which inverter is turned on more strongly. For example, if V_{FUSEm} and V_{REF} exceed the threshold voltage (Vₜₙ) of n-fet transistors N1 and N2, respectively, then transistor N2 turns on more strongly (i.e., sinks more current) than transistor N1 when V_{REF}>V_{FUSEm}. Conversely, n-fet transistor N1 turns on more strongly than n-fet transistor N2 when V_{FUSEm}>V_{REF}. Similarly, if V_{FUSEm} and V_{REF} exceed the threshold voltage (Vₜₚ) of p-fet transistors P1 and P2, respectively, then transistor P2 turns on more strongly than transistor P1 when V_{REF}<V_{FUSEm}. Conversely, p-fet transistor P1 turns on more strongly than p-fet transistor P2 when V_{FUSEm}<V_{REF}.

Accordingly, the soft latch 400 may be conditioned to one of four different states during the charging stage based on the difference between V_{FUSEm} and V_{REF}. The conditioned state of the soft latch 400 determines whether the correct fuse state is sensed and captured. That is, the transistor turned on most strongly during the charging stage determines the output state of the soft latch 400 during the sensing stage. As such, proper selection of V_{REF} ensures accurate and reliable operation of the soft latch 400.

For ease of explanation only, operation of the soft latch 400 is described next based on the m^{th} fuse element 410 having a high pre-programming resistance and a low programmed resistance. Accordingly, V_{FUSEm} is high when the m^{th} fuse element 410 is programmed and low when not programmed. Ideally, V_{FUSEm} approximately equals the voltage V_{PROG} applied to the fuse element 410. However, if the m^{th} fuse element 410 is only partially programmed, then V_{FUSEm} falls between ground and V_{PROG}. The soft latch 400 senses and captures the correct state of the m^{th} fuse element 410 when the reference voltage is at an appropriate level. In the present example, the programmed fuse state is accurately sensed when V_{FUSEm}>V_{REF} and the un-programmed fuse state is accurately sensed when V_{FUSEm}<V_{REF}. Otherwise, fuse sensing may become inaccurate and unreliable.

In more detail, V_{FUSEm} should be greater than V_{REF} when the m^{th} fuse element 410 is programmed so that V_{FUSEm} turns transistor N1 on more strongly than V_{REF} turns on transistor N2. The soft latch 400 is then isolated from V_{REF} and V_{FUSEm} after the latch 400 has been charged. During the sensing stage, p-fet transistor P3 and n-fet transistor N3 are activated, providing power and ground, respectively, to the latch 400. The common drain of the first inverter P1/N1 is driven harder to ground than is the common drain of the second inverter P2/N2 because transistor N1 sinks more current than transistor N2. In turn, the first inverter P1/N1 outputs a stronger logic zero which causes the second inverter pair P2/N2 to eventually output a logic one. A third inverter 440 flips the output of the first inverter P1/N1 to yield a logic one fuse state output which corresponds to the elevated voltage level of V_{FUSEm}. The cross-coupling between the first and second inverters P1/N1 and P2/N2 ensures the soft latch 400 stores the properly sensed fuse state so long as power and ground are provided to the latch 400.

Likewise, V_{FUSEm} should be less than V_{REF} when the m^{th} fuse element 410 is not programmed so that V_{FUSEm} turns transistor P1 on more strongly than V_{REF} turns on transistor P2 during the charging stage. During the sensing stage, the common drain of the first inverter P1/N1 is driven harder to power (V_{INT}) than is the common drain of the second inverter P2/N2 because transistor P1 sinks more current than transistor P2. In turn, the first inverter P1/N1 outputs a stronger logic one which causes the second inverter pair P2/N2 to eventually output a logic zero. The third inverter 440 flips the output of the first inverter P1/N1 to yield a logic zero fuse state output which corresponds to the low voltage level of V_{FUSEm}.

However, fuse sensing is not accurate if V_{FUSEm}<V_{REF} when the m^{th} fuse element 410 is programmed and if V_{FUSEm}>V_{REF} when the fuse element 410 is not programmed. Particularly, transistor N2 is turned on more strongly than transistor N1 when V_{FUSEm} and V_{REF} exceed Vₜₙ, but V_{FUSEm}<V_{REF}. Such a soft latch state is not advantageous when the m^{th} fuse element 410 is programmed because the soft latch 400 senses and captures a logic zero fuse state instead of a logic one. Thus, the soft latch 400 senses and captures the incorrect fuse state when V_{FUSEm} and V_{REF} are above Vₜₙ, but V_{FUSEm}<V_{REF}. Similarly, transistor P2 is turned on more strongly than transistor P1 when V_{FUSEm} and V_{REF} are above Vₜₚ, but V_{FUSEm}>V_{REF}. Such a soft latch state is not advantageous when the m^{th} fuse element 410 is not programmed because the soft latch 400 senses and captures a logic one fuse state instead of a logic zero. Thus, the soft latch 400 senses and captures the incorrect fuse state when V_{FUSEm} and V_{REF} are above Vₜₚ, but V_{FUSEm}>V_{REF}.

Broadly then, a programmed low-resistance fuse state (high fuse output voltage V_{FUSE}) is properly sensed when the fuse voltage exceeds the reference voltage as given by:

V_{FUSE}>V_{REF}≧Vₜₙ (1)

A programmed high-resistance fuse state (low fuse output voltage V_{FUSE}) is properly sensed when the fuse output voltage is less than the reference voltage as given by:

Vₜₚ≦V_{FUSE}<V_{REF} (2)

Similarly, an un-programmed low-resistance fuse state (high fuse output voltage V_{FUSE}) is properly sensed when equation (1) is satisfied and an un-programmed high-resistance fuse state (low fuse output voltage V_{FUSE}) is properly sensed when equation (2) is satisfied.

The voltage output by a fuse element depends upon fuse resistance. Fuse resistance varies with temperature. During normal operation of the IC 100, the fuse controller 300 minimizes the effects of temperature on fuse sensing by adjusting the reference voltage V_{REF} accordingly. This way, the fuse sense circuitry 120 is properly conditioned during fuse sensing. In one embodiment, the temperature-to-voltage converter 140 selects a reference voltage value based on the temperature measurement derived by the temperature sensor 130. The reference voltage selected by the converter 140 satisfies equations (1) and (2) during normal operation of the IC 100, thus ensuring the fuse sense circuitry 120 accurately and reliably senses the state of the fuse array 110.

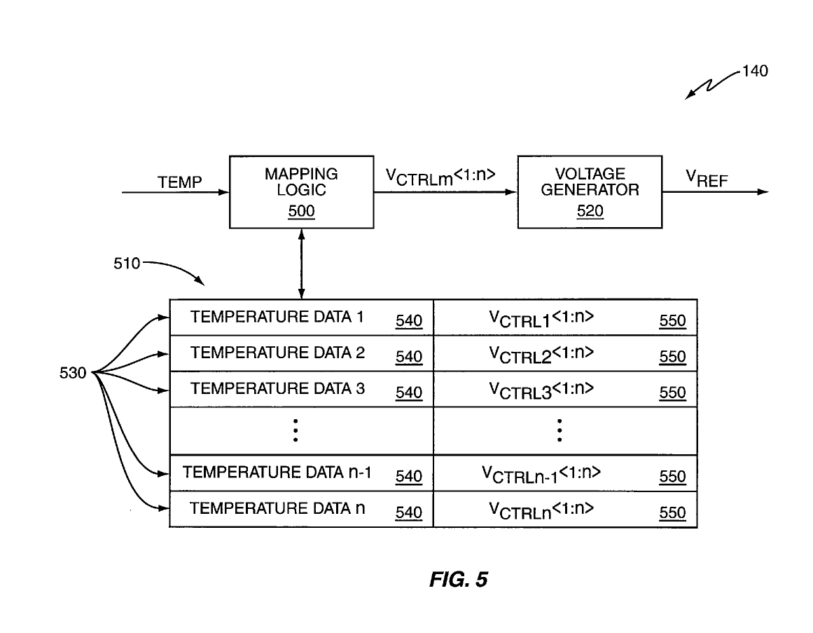

FIG. 5 illustrates an embodiment of the temperature-to-voltage converter 140. The converter 140 includes mapping logic 500, a table 510 and a voltage generator 520. The mapping logic 500 compares a temperature measurement (TEMP) derived by the temperature sensor 130 to one or more records 530 maintained by the table 510. The table 510 identifies a digital control word (V_{CTRLm}<1:n>) representing a reference voltage level that satisfies equations (1) and (2) for the temperature measurement provided to the converter 140. This way, as temperature varies, the reference voltage used during fuse sensing ensures accurate and reliable operation of the fuse sense circuitry 120.

In more detail, the table 510 comprises a plurality of records 530. Each record 530 contains a temperature entry 540 and a corresponding voltage entry 550. Each temperature entry 540 identifies a specific temperature value or range of temperature values (TEMPERATURE DATA1-n). The corresponding voltage entries 550 store a digital control word (V_{CTRL1-n}<1:n>) representing a reference voltage to be used during fuse sensing. The records 530 maintained by the table 510 may be populated based on actual test data previously collected and analyzed. Alternatively, the records 530 may be populated based on data derived during simulation. Regardless, the temperature-to-voltage mapping provided by the table 510 ensures the reference voltage used by the sense circuitry 120 enables accurate and reliable fuse sensing.

In one embodiment, the table 510 is implemented as a state machine or other combinatorial logic configured to provide a digital control word representing a reference voltage based on a given temperature measurement. In another embodiment, the table 510 is implemented as a Content Addressable Memory (CAM). According to the CAM embodiment, the temperature measurement is compared to the temperature entries 540. In the event of a match, the corresponding digital control word is output by the CAM. One or more bits of the temperature measurement may be masked when presented to the CAM. This way, each temperature entry 540 in the CAM may represent a range of temperature values instead of a single value, e.g., 5° C. or 10° C. ranges.

Regardless, the mapping logic 500 provides the identified digital control word to the voltage generator 520 for generation of the reference voltage V_{REF} as is well known in the art. The sense circuitry 120 uses the reference voltage for sensing the fuse array 110 during normal operation of the IC 100 as previously described. Alternatively, the sense circuitry 120 uses a different reference voltage as generated by the fuse controller 300 when the IC 100 is configured in test mode.

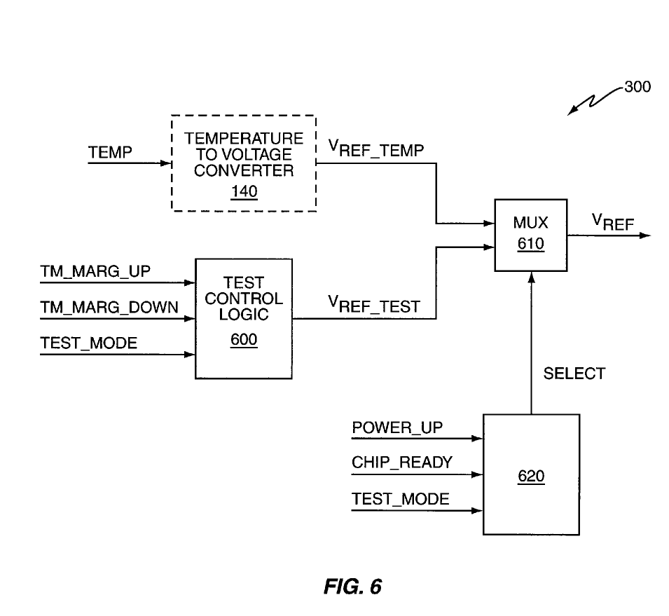

FIG. 6 illustrates an embodiment of the fuse controller 300. According to this embodiment, the fuse controller 300 is configured to provide a temperature-based reference voltage (V_{REF}_{_{—}}_{TEMP}) to the latch circuitry 330 during normal operation of the IC 100 and a different reference voltage (V_{REF}_{_{—}}_{TEST}) to the latch circuitry 330 when the IC 100 is configured in test mode. The temperature-based reference voltage is generated by the temperature-to-voltage converter 140 responsive to temperature as previously described. Test control logic 600 included in or associated with the fuse controller 300 generates a different reference voltage for use in sensing the fuse array 110 during testing.

A multiplexer circuit 610 selects one of the reference voltages based on the current state of the IC 100 and provides the selected reference voltage (V_{REF}) to the latch circuitry 330 during fuse sensing. In one embodiment, a select signal (SELECT) causes the temperature-based reference voltage to be selected during normal operation and the other reference voltage to be selected during test. Logic 620 included in the fuse controller 300 generates the select signal based on the current operating state of the IC 100. The logic 620 receives three signals indicating IC status. A power-up signal (POWER_UP) indicates that the IC 100 has been activated. The IC 100 initializes itself during power-up. The IC 100 issues an IC-ready signal (IC_READY) when the IC 100 is ready to process information after completing initialization. A test mode signal (TEST_MODE) indicates the IC 100 is to be configured for testing. The IC 100 operates in a normal mode so long as the power-up signal is active and the test mode signal is inactive. In one embodiment, fuse sensing occurs either during normal IC operation when the IC 100 is performing initialization or during test. Accordingly, the multiplexer 610 selects the temperature-based reference voltage V_{REF}_{_{—}}_{TEMP} when the POWER_UP signal is active and the IC_READY and TEST_MODE signals are both inactive. Conversely, the multiplexer 610 selects the reference voltage V_{REF}_{_{—}}_{TEST} output by the test control logic 600 when the POWER_UP and TEST_MODE signals are both active. Otherwise, the fuse controller 300 is inactive according to this embodiment.

With the above range of variations and applications in mind, it should be understood that the present invention is not limited by the foregoing description, nor is it limited by the accompanying drawings. Instead, the present invention is limited only by the following claims and their legal equivalents.

What is claimed is:

1. A method of fuse sensing in an integrated circuit, comprising:
selecting a reference voltage based on a temperature measurement acquired by the integrated circuit; and
sensing a state of one or more fuses included in the integrated circuit based on the reference voltage during normal operation of the integrated circuit.

2. The method of claim 1, wherein sensing the state of the one or more fuses comprises:
applying the reference voltage to circuitry included in the integrated circuit configured to sense the state of the one or more fuses; and
sensing the state of the one or more fuses by the circuitry after the reference voltage is removed from the circuitry.

3. The method of claim 1, wherein selecting the reference voltage based on the temperature measurement comprises selecting the reference voltage while the integrated circuit is powering up.

4. The method of claim 1, wherein selecting the reference voltage based on the temperature measurement comprises:
converting the temperature measurement to a digital control word; and
converting the digital control word to the reference voltage.

5. The method of claim 4, wherein converting the temperature measurement to the digital control word comprises:
comparing the temperature measurement to one or more entries in a table included in the integrated circuit; and
retrieving the entry matching the temperature measurement.

6. The method of claim 1, further comprising sensing the state of the one or more fuses based on a different reference voltage during testing of the integrated circuit.

7. An integrated circuit, comprising:
one or more fuses; and
circuitry configured to select a reference voltage based on a temperature measurement acquired by the integrated circuit and to sense a state of the one or more fuses based on the reference voltage during normal operation of the integrated circuit.

8. The integrated circuit of claim 7, wherein the circuitry comprises latch circuitry configured to charge while the reference voltage is applied to the latch circuitry and to sense the state of the one or more fuses after the reference voltage is removed from the latch circuitry.

9. The integrated circuit of claim 7, wherein the circuitry is configured to select the reference voltage while the integrated circuit is powering up.

10. The integrated circuit of claim 7, wherein the circuitry is configured to convert the temperature measurement to a digital control word and to convert the digital control word to the reference voltage.

11. The integrated circuit of claim 10, wherein the circuitry is configured to compare the temperature measurement to one or more entries in a table included in the integrated circuit and to retrieve the entry matching the temperature measurement.

12. The integrated circuit of claim 7, wherein the circuitry is further configured to sense the state of the one or more fuses based on a different reference voltage during testing of the integrated circuit.

13. An integrated circuit, comprising:
one or more fuses; and
means for selecting a reference voltage based on a temperature measurement acquired by the integrated circuit and sensing a state of the one or more fuses based on the reference voltage during normal operation of the integrated circuit.

14. A method of fuse sensing in an integrated circuit, comprising:
selecting a reference voltage based on a temperature measurement acquired by the integrated circuit;
sensing a state of one or more fuses included in the integrated circuit based on the reference voltage during normal operation of the integrated circuit; and
sensing the state of the one or more fuses based on a different reference voltage during testing of the integrated circuit.

15. The method of claim 14, wherein sensing the state of the one or more fuses based on the reference voltage during normal operation of the integrated circuit comprises:
applying the reference voltage to circuitry included in the integrated circuit configured to sense the state of the one or more fuses; and
sensing the state of the one or more fuses by the circuitry after the reference voltage is removed from the circuitry.

16. The method of claim 14, wherein selecting the reference voltage based on the temperature measurement comprises selecting the reference voltage while the integrated circuit is powering up.

17. The method of claim 14, wherein selecting the reference voltage based on the temperature measurement comprises:
converting the temperature measurement to a digital control word; and
converting the digital control word to the reference voltage.

18. The method of claim 17, wherein converting the temperature measurement to the digital control word comprises:
comparing the temperature measurement to one or more entries in a table included in the integrated circuit; and
retrieving the entry matching the temperature measurement.

19. An integrated circuit, comprising:
one or more fuses; and
circuitry configured to:
select a reference voltage based on a temperature measurement acquired by the integrated circuit;
sense a state of the one or more fuses based on the reference voltage during normal operation of the integrated circuit; and
sense the state of the one or more fuses based on a different reference voltage during testing of the integrated circuit.

20. The integrated circuit of claim 19, wherein the circuitry comprises latch circuitry configured to charge while the reference voltage is applied to the latch circuitry and to sense the state of the one or more fuses after the reference voltage is removed from the latch circuitry.

21. The integrated circuit of claim 19, wherein the circuitry is configured to select the reference voltage while the integrated circuit is powering up.

22. The integrated circuit of claim 19, wherein the circuitry is configured to convert the temperature measurement to a digital control word and to convert the digital control word to the reference voltage.

23. The integrated circuit of claim 22, wherein the circuitry is configured to compare the temperature measurement to one or more entries in a table included in the integrated circuit and to retrieve the entry matching the temperature measurement.
